(19) United States
(12) Patent Application Publication
(10) Pub. No.: US 2022/0341250 A1
(43) Pub. Date: Oct. 27, 2022

(54) Concealed Safe Apparatus

(71) Applicant: James Battaglia, Kansas City, MO (US)

(72) Inventor: James Battaglia, Kansas City, MO (US)

(21) Appl. No.: 17/400,449

(22) Filed: Aug. 12, 2021

Related U.S. Application Data
(60) Provisional application No. 63/180,152, filed on Apr. 27, 2021.

(51) Int. Cl. E05G 1/024; E05G 1/04; E05G 1/06

(52) U.S. Cl. CPC E05G 1/024; E05G 1/04; E05G 1/06; F24H 1/18

(57) ABSTRACT

A concealed safe apparatus for protecting valuables disguised to blend into a home environment. An exterior of the safe apparatus resembles a hot water heater that can be installed in a basement, garage, or similar area that would normally house a home water heater. The safe apparatus is configured to protect a wide variety of valuables from theft, fire, and environmental hazards. An internal vault of the safe apparatus is encased in an exterior resembling a cylindrical tank of the hot water heater. The internal vault is accessed by a disguised access door securable with a locking mechanism.

### CROSS-REFERENCE TO RELATED APPLICATION

The present application claims priority to, and the benefit of, U.S. Provisional Application No. 63/180,152, which was filed on Apr. 27, 2021 and is incorporated herein by reference in its entirety.

### FIELD OF THE INVENTION

The present invention generally relates to a way to protect valuables, and more specifically to a safe disguised as a home water heater tank. Accordingly, the present specification makes specific reference thereto. However, it is to be appreciated that aspects of the present invention are also equally amenable to other like applications, devices, and methods of manufacture.

### BACKGROUND OF THE INVENTION

People may lack proper secure storage areas for their valuables in a home, such as jewelry, firearms, money, documents, and the like. A standard safe or vault may stick out and be easily visible to intruders leading to the safe being broken into or stolen. This can put people at risk during a burglary as people could be forced to open a safe at gunpoint if it was openly obvious. As an alternative, people may store their valuables in seemingly inconspicuous areas of the home only to have them stolen regardless if an unauthorized individual enters the home.

A safe is a secure lockable container that is used for securing valuable objects against theft and/or damage from fire. A safe is typically constructed as a hollow cuboid or cylinder, with one face being removable or hinged to form a door. The body and door may be cast from metal or formed out of hardened plastic. Bank teller safes typically are secured to the counter, have a slit opening for dropping valuables into the safe without opening it, and a time-delay combination lock to deter robbers. One significant distinction between types of safes is whether the safe is secured to a wall or structure or if it can be moved around. A less secure smaller version of a safe is called a cash-box.

Common types of safes include burglar-resistant, fire-resistant, environmental resistant, type of lock (e.g. key, combination, electronic, time lock), location, and smart safes. Fire resistant record protection safes are self-contained containers constructed with insulated bodies, doors, drawers or lids, or non-rated multi-drawer devices housing individually rated containers that contain one or more inner compartments for storage of important documents. In addition, these types of enclosures may be rated for impact resistance, should the safe fall to a lower level or have debris fall upon it during a fire. Burglary resistant safes are generally rated by their resistance to the type of tools to be used in an attempted breach and also the duration of the attack.

Most home safes are smaller and less protective than commercial safes. As such, they are often designed to be hidden or concealed. For example, it is common for a home safe to be built into a wall or part of the house structure. These may also be hidden by a hanging picture or furniture. Home safes that are not built into structure are generally placed in concealed areas such as closets, basements, attics, or similar less visible area as they would otherwise be easily removable by a burglar for later breach in a safer area.

Accordingly, there is a great need for a better way to protect one's valuables in the home. There is also a need for a way for conceal or disguise a home safe in a way that is not easily apparent to an intruder. Similarly, there is a need for a securing container that is camouflaged to look like an ordinary home appliance. Further, there is a need for an inconspicuous option to a standard ordinary home safe.

In this manner, the improved home safe of the present invention accomplishes all of the forgoing objectives, thereby providing an easy solution for protecting valuables in the home. A primary feature of the present invention is a concealed safe that blends in with a common home appliance that is not readily discoverable by a thief. The present invention allows the user to protect valuables in the home from a variety of hazards. Finally, the improved concealed safe of the present invention is capable of disguising and protecting a wide variety of items from theft, fire, and environmental hazards while in plain sight.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a concealed safe apparatus. The concealed safe apparatus is configured to retain and protect a variety of valuables that can be housed in a safe. The concealed safe apparatus is configured to resemble an appliance, such as a water tank or hot water heater, that can be placed in plain sight without an obvious indication that it is protecting valuable contents.

The concealed safe apparatus comprises a vault component, a locking component, and at least one external disguising component. The vault component is cylindrical in construction and comprises an exterior shell and a secure storage container. The exterior shell comprises a cylindrical sidewall connected by a top and a base. A door is cut into the cylindrical sidewall with and a disguised seam conceals the door edges. The exterior shell encapsulates the secure storage container.

The secure storage container similarly comprises a cylindrical sidewall connected by a top and a base defining an interior cavity. The interior cavity is accessible via a door in the cylindrical sidewall of the secure storage container. The door of the secure storage container aligns with the door in the exterior shell to function as a single unit. The secure storage container seals and is water-proof when the door is secured.

The vault component may further comprise an insulating layer. The insulating layer is sandwiched between the exterior shell and the secure storage container. The insulating layer provides fireproofing and insulation for temperature regulation within the interior cavity of the secure storage container.

The vault component may further comprise a valuables retaining module. The valuables retaining module is positional within the interior cavity of the secure storage container. The valuables retaining module comprises a circular base and at least one shelf connected by a shaft. The valuables retaining module is rotatable within the interior cavity. The circular base and the at least one shelf are configured to retain and secure valuables within the secure storage container.

The locking component locks and unlocks the doors to access the interior cavity of the secure storage container. The locking component may have a disguised external access with a locking mechanism housed between the door of the exterior shell and the door of the secure storage container. The locking component may comprise a magnetic, biometric, or traditional lock system.

The at least one external disguising component is attached to the exterior shell. The at least one external disguising component may comprise a plurality of external elements. The plurality of external elements are designed to resemble external fittings and components of a traditional hot water heater.

The concealed safe apparatus may further comprise an environmental control component. The environmental control component is used to condition or regulate the air inside the interior cavity of the secure storage container. The concealed safe apparatus may further comprise a lighting component. The lighting component is positional within the interior cavity of the secure storage container.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a standalone perspective view of a concealed safe apparatus of the present invention for protecting valuables in accordance with the disclosed architecture.

FIG. 2 illustrates a perspective view of an interior of the concealed safe apparatus of the present invention for protecting valuables in accordance with the disclosed architecture.

FIG. 3 illustrates a perspective view of a vault component of the concealed safe apparatus of the present invention for protecting valuables in accordance with the disclosed architecture.

FIG. 4 illustrates a perspective view of a valuables retaining module of the concealed safe apparatus of the present invention for protecting valuables in accordance with the disclosed architecture.

FIG. 5 illustrates a perspective view of the interior of the interior of the concealed safe apparatus of the present invention for protecting valuables in accordance with the disclosed architecture.

FIG. 6 illustrates a close up view of an upper storage shelf of the concealed safe apparatus of the present invention for protecting valuables in accordance with the disclosed architecture.

FIG. 7 illustrates a close up view of a locking mechanism of the concealed safe apparatus of the present invention for protecting valuables in accordance with the disclosed architecture.

FIG. 8 illustrates a perspective view of the concealed safe apparatus of the present invention for protecting valuables installed in plain view in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, provides users with an improved safe resembling a water tank of a water heater. The safe features an interior volume with a rotating cylindrical base and a plurality of storage shelves for storing a variety of valuables. Additional features include automatic LED lighting, a dehumidifier to control interior air quality and conditions, and fireproofing to maximize protection and offer convenience while using the safe. The safe is configured to prevent valuable items from being noticed and stolen during unauthorized access to the home. The present invention replaces standard safes and offers a more inconspicuous option for protecting valuables.

The concealed safe is a multifunctional, secure safe system for disguising the location of valuables in a home. The safe if configured to resemble a home appliance and can be installed in a basement area, a garage, a pool house, an attic, or any other area that would typically house a water heater tank. A plurality of deadbolt locks and a magnetic latch are integrated into a metal, fireproof cylindrical body. The internal vault is accessible via a swinging door openable by the magnetic latch and locks.

An interior feature comprises a rotating shelf and base for firearms, jewelry, money, and much more. There can be additional shelves installed as desired. An internal dehumidifier may be used to keep the air quality at optimal levels. Other features comprise a cabinet metal thickness of typically 10-gauge or 8-gauge, LED interior lighting that can automatically activate upon opening of the door, and fireproofing materials. The system can be powered via an electrical connection or other power means. Users can open the system and store items inside for safe keeping while the inconspicuous nature of a water tank prevents intruders from easily noticing where valuables are stored.

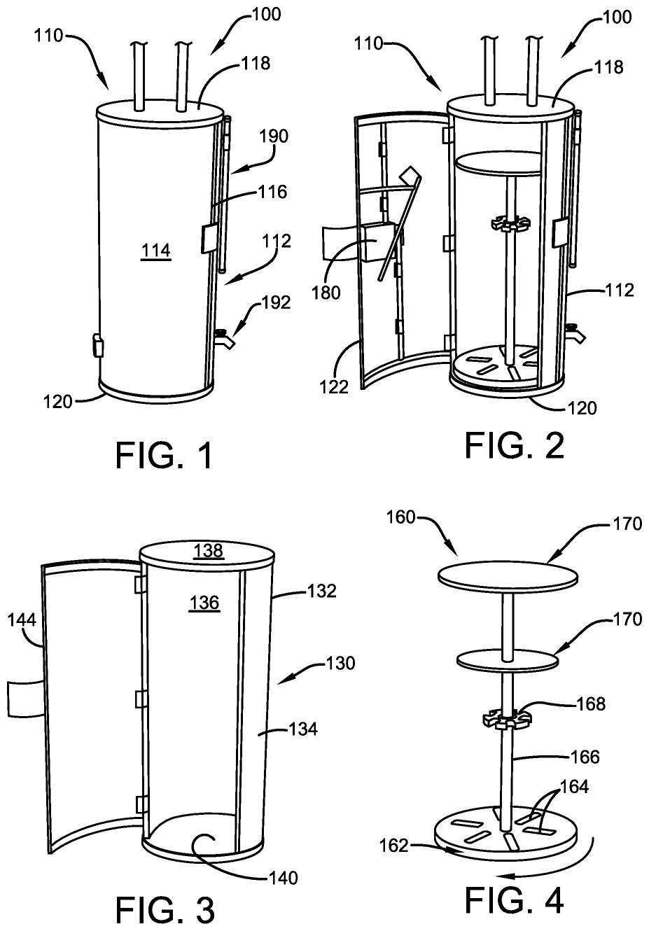

Referring initially to the drawings, FIGS. 1-8 illustrate a concealed safe apparatus 100. The concealed safe apparatus 100 is configured to retain and protect a variety of valuables that can be housed in a traditional safe. As illustrated in FIG. 8, the concealed safe apparatus 100 is configured to resemble an appliance, such as a water tank or a hot water heater. The concealed safe apparatus 100 can be placed in plain sight in a functional area without an obvious indication that it is protecting valuable contents.

As illustrated in FIGS. 1 and 2, the concealed safe apparatus 100 comprises a vault component 110, a locking component 180, and at least one external disguising component 190. The vault component 110 is generally cylindrical in shape, with dimensions comparable to a traditional hot water heater. The vault component 110 comprises an exterior shell 112 and a secure storage container 130. The exterior shell 112 comprises a cylindrical sidewall 114 connected by a circular top 118 and a circular base 120. The exterior shell 112 is typically manufactured from thin sheet metal typically used to construct a traditional hot water tank. A door 122 is cut into the cylindrical sidewall 114. The edges of the door 122 are concealed with a disguised seam 116 for camouflage. The exterior shell is slightly larger in dimension than the secure storage container 130 and encapsulates the secure storage container 130 within.

As illustrated in FIG. 3. the secure storage container 130 similarly comprises a cylindrical sidewall 132 connected by a circular top 138 and a circular base 140 defining an interior cavity 142. The cylindrical sidewall 132 comprises an exterior surface 134 facing the exterior shell 112 and an interior surface 136 facing the interior cavity 142. The secure storage container 130 is typically manufactured from a heavier gauge metal or composite material typically used to construct a traditional safe. The interior cavity 142 is accessible via a door 144 in the cylindrical sidewall 132 of the secure storage container 130. The door 144 of the secure storage container 130 is configured to align with the door 122 in the exterior shell 122 so that both doors 122 and 144 function essentially as a single unit. The secure storage container 130 seals and is water-resistant when the door 144 is closed and secured.

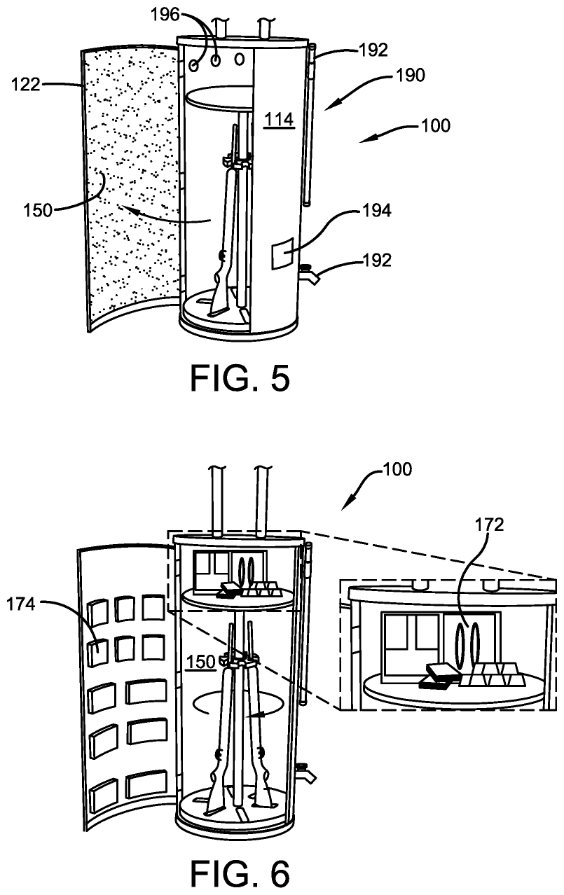

As illustrated in FIG. 5, the vault component 110 may further comprise an insulating layer 150. The insulating layer 150 is sandwiched between an interior of the exterior shell 112 and the exterior surface 134 of the secure storage container 130. The insulating layer 150 provides fireproofing and insulation for interior temperature regulation within the interior cavity 142 of the secure storage container 130. The insulating layer 150 may be a polyethylene or neoprene foam blanket, fiberglass barrier layer, or similar material. The insulating layer 150 may have a one-hour or greater fireproof or resistant rating.

As illustrated in FIGS. 4 and 6, the vault component 110 may further comprise a valuables retaining module 160. The valuables retaining module 160 is positional within the interior cavity 142 of the secure storage container 130. The valuables retaining module 142 may comprise a circular base 162 and at least one circular shelf 170 connected by a shaft 166. The valuables retaining module 142 is rotatable within the interior cavity 142. The circular base 162 and the at least one circular shelf 170 are configured to retain and secure valuables within the secure storage container 130. The at least one circular shelf 170 may be any number of shelves as will fit and as desired.

The valuables retaining module 142 is configured to store a variety of valuables, such as, but not limited to firearms, weapons, cash, jewelry, important documents, electronic storage media, art, and the like. The circular base 162 may comprise a plurality of base engaging elements 164 and the shaft 166 may comprise a plurality of shaft engaging elements 168. The plurality of base engaging elements 164 and the plurality of shaft engaging elements 168 may be configured to retain and secure a plurality of firearms in an upright orientation. The valuables retaining module 142 may further comprise a plurality of hangers or brackets 172 and a plurality of door pockets 174. The hangers or brackets 172 and door pockets 174 are usable to separate and retain valuables throughout the interior cavity 142.

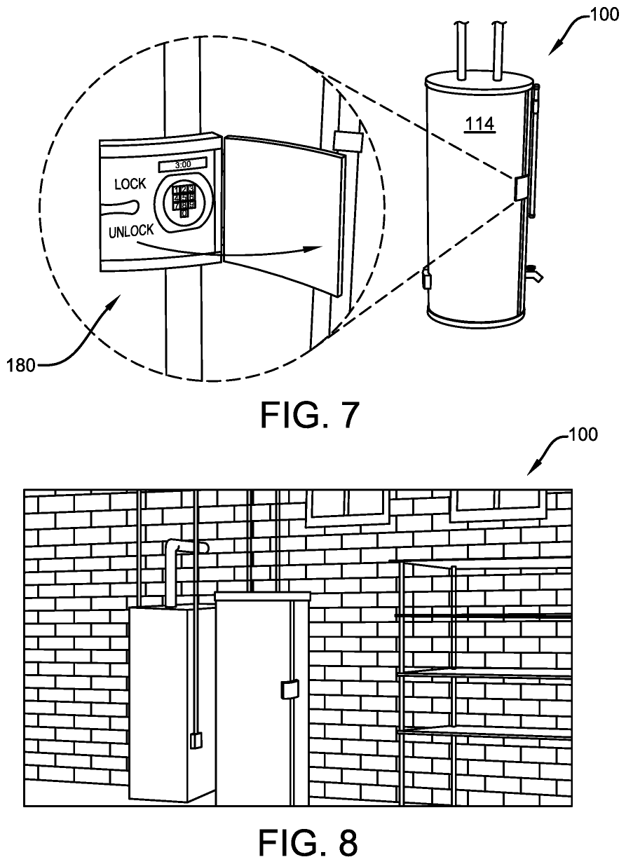

As illustrated in FIG. 7, the locking component 180 locks and unlocks the doors 122 and 144 to access the interior cavity 142 of the secure storage container 130. The locking component 180 may have a disguised external access resembling a water heater control box attached to the exterior shell 112. The locking component 180 may further comprise a locking mechanism, such as a deadbolt lock system housed between the door 122 of the exterior shell 112 and the door 144 of the secure storage container 130. The locking component 180 may be a magnetic lock system. The locking component 180 may be accessed and operated via a biometric input, a timer, a keypad, a key, an electronic lock, or the like. In one example, the locking component 180 may be biometric with a door cover plate employing magnetic latches to keep the door closed and discrete.

The at least one external disguising component 190 is attached to the exterior shell 122. The at least one external disguising component 190 may comprise a plurality of external elements 192. The plurality of external elements 192 are designed to resemble external fittings and components of a traditional hot water heater, such as drain valves, pressure relief valves, piping, control boxes, thermostats, or the like.

As illustrated in FIG. 5, the concealed safe apparatus 100 may further comprise an environmental control component 194. The environmental control component 194 is used to condition or regulate the air or humidity inside the interior cavity of the secure storage container 130. The environmental control component 194 may be a dehumidifier, a fan, a heater, or combination thereof. The concealed safe apparatus 100 may further comprise a lighting component 196. The lighting component 196 is positional within the interior cavity 142 of the secure storage container 130. The lighting component 196 may be a strip light, LED, or the like. The lighting component 196 may be activatable when the door 144 of the secure storage container 130 is opened, by a motion sensor, or by an on/off switch. The concealed safe apparatus 100 is connectable to a home electric grid or may be battery powered.

Notwithstanding the forgoing, the concealed safe apparatus 100 can be any suitable size, shape, and configuration as is known in the art without affecting the overall concept of the invention, provided that it accomplishes the above stated objectives. One of ordinary skill in the art will appreciate that the shape and size of the concealed safe apparatus 100 and its various components, as show in the FIGS. are for illustrative purposes only, and that many other shapes and sizes of the concealed safe apparatus 100 are well within the scope of the present disclosure. Although dimensions of the concealed safe apparatus 100 and its components (i.e., length, width, and height) are important design parameters for good performance, the concealed safe apparatus 100 and its various components may be any shape or size that ensures optimal performance during use and/or that suits user need and/or preference. As such, the concealed safe apparatus 100 may be comprised of sizing/shaping that is appropriate and specific in regard to whatever the concealed safe apparatus 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A concealed safe apparatus comprising:
a vault component comprising:
a secure storage container defining an interior cavity accessible via a door; and
an exterior shell encapsulating the secure storage container;
a locking component for locking and unlocking the door to access the interior cavity; and
at least one external disguising component attached to the exterior shell.

2. The concealed safe apparatus of claim 1, wherein the vault component is cylindrical.

3. The concealed safe apparatus of claim 1, wherein the concealed safe apparatus resembles a water tank.

4. The concealed safe apparatus of claim 1, wherein the concealed safe apparatus resembles a hot water heater.

5. The concealed safe apparatus of claim 1, wherein the vault component further comprises an insulating layer sandwiched between the exterior shell and the secure storage container.

6. The concealed safe apparatus of claim 5, wherein the vault component has at least a one-hour fireproof rating.

7. The concealed safe apparatus of claim 1, wherein the secure storage container is water-resistant when the door is secured.

8. The concealed safe apparatus of claim 1, wherein the vault component further comprises a valuables retaining module positional within the interior cavity of the secure storage container.

9. The concealed safe apparatus of claim 8, wherein the valuables retaining module rotates within the interior cavity.

10. The concealed safe apparatus of claim 8, wherein the valuables retaining module is configured to hold a plurality of firearms upright.

11. The concealed safe apparatus of claim 8, wherein the valuables retaining module comprises a circular base and at least one shelf connected by a shaft.

12. The concealed safe apparatus of claim 1, wherein the locking component comprises a magnetic element.

13. The concealed safe apparatus of claim 1, wherein the locking component is operated via a biometric input.

14. The concealed safe apparatus of claim 1, wherein the locking component is operated via a timer.

15. The concealed safe apparatus of claim 1, wherein the at least one external disguising component comprises a plurality of external elements resembling external fittings of a hot water heater.

16. The concealed safe apparatus of claim 1 further comprising an environmental control component for conditioning air within the interior cavity.

17. The concealed safe apparatus of claim 1 further comprising a lighting component inside the secure storage container.

18. A concealed safe apparatus comprising:
a cylindrical vault component comprising:
a secure storage container defining an interior cavity accessible via a door; and
an exterior shell encapsulating the secure storage container;
an insulating layer sandwiched between the exterior shell and the secure storage container; and
a locking component for locking and unlocking the door to access the interior cavity; and
at least one external disguising component attached to the exterior shell comprising a plurality of external elements resembling external fittings of a hot water heater.

19. The concealed safe apparatus of claim 18, wherein the cylindrical vault component further comprises a valuables retaining module rotatable within the interior cavity of the secure storage container.

20. A concealed safe apparatus comprising:
a cylindrical vault component comprising:
a secure storage container defining an interior cavity accessible via a door; and
an exterior shell encapsulating the secure storage container;
an insulating layer sandwiched between the exterior shell and the secure storage container;
a valuables retaining module rotatable within the interior cavity of the secure storage container; and
a locking component for locking and unlocking the door to access the interior cavity;
at least one external disguising component attached to the exterior shell comprising a plurality of external elements resembling external fittings of a hot water heater;
an environmental control component for conditioning air within the interior cavity; and
a lighting component inside the secure storage container activatable when the door of the secure storage container is opened.
